(19) United States
(12) Patent Application Publication
(10) Pub. No.: US 2016/0026824 A1
(43) Pub. Date: Jan. 28, 2016

(54) SECURITY AGAINST MEMORY REPLAY ATTACKS IN COMPUTING SYSTEMS

(71) Applicant: The Boeing Company, Chicago, IL (US)

(72) Inventor: Laszlo Hars, Lafayette, CO (US)

(73) Assignee: The Boeing Company, Chicago, IL (US)

(21) Appl. No.: 14/340,294

(22) Filed: Jul. 24, 2014

(51) Int. Cl. G06F 21/64; G06F 12/14

(52) U.S. Cl. CPC G06F 21/64; G06F 12/14

(57) ABSTRACT

A method of providing security for data stored in external memory in a computing system comprises storing a reference updatable hash value for each protected window of the external memory. Each reference value is stored in internal memory of the computing system. The method further comprises continually generating a current hash value for each protected window and comparing each current hash value to its corresponding reference hash value.

### BACKGROUND

A memory replay attack involves accessing data from computer-readable memory in a computing system, and writing the data back to the memory at a later time. The data may be encrypted or unencrypted. The memory replay attack can cause harmful behavior of the computing system and lead to exposure of data. A memory replay attack may be used to reset a computing system to an earlier state, when former users or software agents were authenticated, and/or when previous actions were authorized. By resetting a computer system, authorizations can be illicitly extended.

A memory replay attack may be used to undo financial transactions. A memory replay attack may be used to falsify logs, records, or force repeating (now illegal) actions of the computing system.

A memory replay attack may be used to reset event counters to cause improper behavior of a computing system. For instance, a computing system can be forced into a state that enables its operation to be observed and understood.

A memory replay attack is different than a traditional replay attack, which is a form of network attack in which a valid data transmission is maliciously or fraudulently repeated or delayed. The traditional replay attack is carried out either by the originator or by an adversary who intercepts data and retransmits it. The traditional replay attack may be thwarted by using session tokens, time stamping and one-time passwords. However, these countermeasures are not effective for memory replay attacks.

### SUMMARY

According to an embodiment herein, a method of providing security for data stored in external memory in a computing system comprises storing a reference updatable hash value for each protected window of the external memory. Each reference value is stored in internal memory of the computing system. The method further comprises continually generating a current hash value for each protected window and comparing each current hash value to its corresponding reference hash value.

According to another embodiment herein, a computing system comprises volatile random access memory, internal memory, and a dedicated processor. The processor is configured to store a reference updatable hash value for each protected window of the volatile memory, where each reference hash value is stored in the internal memory; and continually generate a current hash value for each protected window and compare each current hash value to its corresponding reference hash value.

According to another embodiment herein, a system-on-chip for protecting external memory from a memory replay attack comprises a microprocessor, internal memory, and a dedicated processor. The dedicated processor is configured to store reference hash values corresponding to protected windows of the external memory, and continually generate a current hash value for each protected window and compare each current hash value to its corresponding reference hash value. The reference hash values are stored in the internal memory.

These features and functions may be achieved independently in various embodiments or may be combined in other embodiments. Further details of the embodiments can be seen with reference to the following description and drawings.

### BRIEF DESCRIPTION OF THE DRAWINGS

FIG. 1 is an illustration of a computing system that provides security against memory replay attacks.

FIG. 2 is an illustration of a method of providing security against memory replay attacks in a computing system.

FIG. 3 is an illustration of a method of updating a reference hash value during a write event.

FIGS. 4 and 5 are illustrations of different examples of a computing system that provides security against memory replay attacks.

FIGS. 6, 7 and 8 are illustrations of enhancements to the method of providing security against memory replay attacks in a computing system.

### DETAILED DESCRIPTION

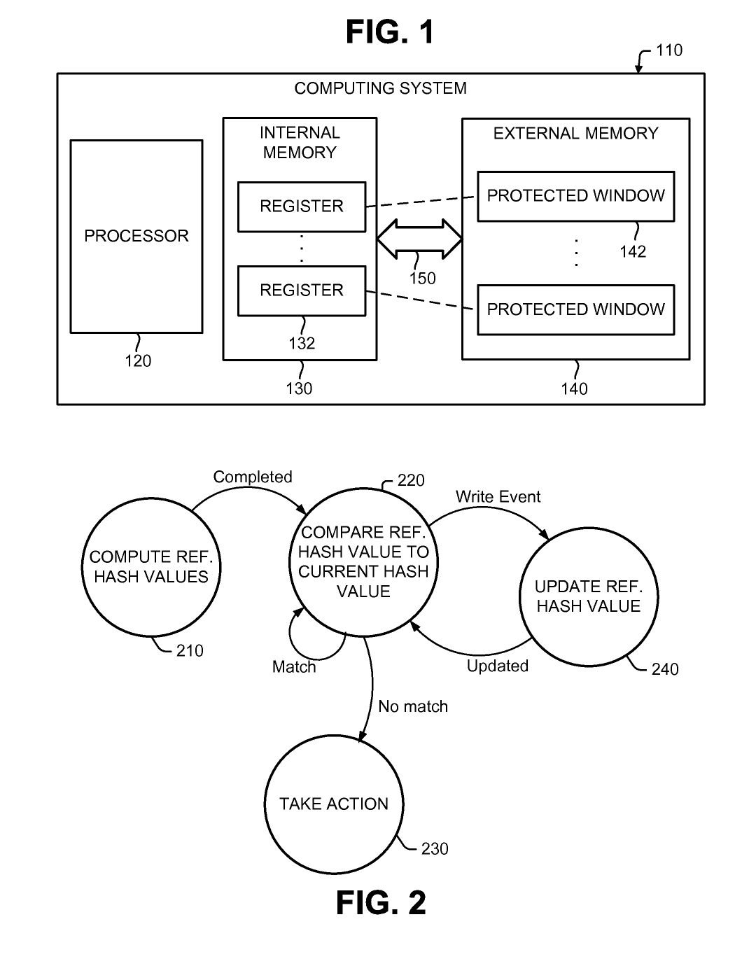

Reference is made to FIG. 1, which illustrates a computing system 110 including a processor 120, internal memory 130, and external memory 140. Examples of the processor 120 include, but are not limited to, central processing units, embedded processors (e.g., DMA engines), and application-specific circuits.

As used herein, the internal memory 130 refers to memory that is accessible only by the processor 120. For example, the internal memory 130 of FIG. 1 includes a plurality of registers 132.

As used herein, the external memory 140 refers to memory that can be accessed by an attacker. For instance, the processor 120 communicates with the external memory 140 via a data path 150 that can be accessed by an attacker. Or, the external memory 140 can be removed from the computing system 110 and accessed by an attacker. The external memory 140 may include, but is not limited to, volatile system memory such as DRAM. In some embodiments, however, the external memory 140 may include non-volatile storage such as hard drives and solid state memory.

The external memory 140 stores data. Some or all of the data stored in the external memory 140 is protected against memory replay attacks. This protected data is stored in protected windows 142. As used herein, a “protected window” refers to a single memory address or a range of contiguous addresses in the external memory 140. In some instances, the protected data may be stored in a single protected window 142, which may cover a portion of the external memory 140 or all of the external memory 140. In other instances, the protected data may be stored in multiple protected windows 142, which may cover a portion of the external memory 140 or all of the external memory 140. The data stored in each protected window may or may not be protected by other means (e.g., encryption and/or data authentication tags).

Additional reference is made to FIG. 2, which illustrates a general method of providing security against memory replay attacks in the computing system 110. The method is illustrated as a state diagram. The method begins at state 210, which is initialization of the computing system 110. At initialization, the processor 120 uses an updatable hash function to compute a reference hash value for each protected window 142, and stores the reference hash values in the internal memory 130. For example, the reference hash values may be stored in the internal registers 132, with each internal register 132 corresponding to a protected window 142 (as depicted by the dashed lines in FIG. 1).

The updatable hash function may be, for example, a checksum function. The processor 120 may compute a checksum for all of the data in a protected window 142 by arithmetic additions or bitwise XOR functions (e.g., Galois field additions). However, the updatable hash function is not limited to checksums. A reversible two-argument function may be used. For example, an arbitrary function may be applied to the data blocks before the summation. This arbitrary function may depend on the location of the data and the data itself.

After initialization, the method advances to state 220. At state 220, the processor 120 generates a current hash value for each protected window 142 and compares each current hash value to its corresponding reference hash value stored in the internal memory 130. If the data in a protected window 142 is illicitly changed, the current hash value will not match the reference hash value stored in the internal memory 130.

The hash value generation and comparison at state 220 may be performed continually until a mismatch occurs or until a write event occurs. Consider the example of the external memory 140 having a number N of protected windows 142. At state 220, the processor 120 “processes” each of the protected windows 142. For each protected window 142, the processor 120 generates a current hash value and compares the current hash value to its corresponding reference hash value. The protected windows 142 may be processed concurrently or sequentially. After all of the N protected windows 142 have been processed, the processor 120 loops back and once again processes all N protected windows 142. The processor 120 continually loops back after the N protected windows 142 have been processed.

If a current hash value does not match its corresponding reference hash value, the method advances to state 230. At state 230, the processor 120 takes an action such as a reactive measure against a memory replay attack. The action may be prescribed by a security policy of the computing system 110. As examples, the computing system 110 may be shut down; internal and external memory 130 and 140 may be cleared; an event counter may be updated and further actions taken if a preset limit is reached; a user may be notified; an event may be logged; and long term secrets (master keys, ROM configuration values, e-fuses) may be cleared.

A write event to the external memory 140 may be initiated by the processor 120, a DMA engine, I/O or other active component of the computing system 110. During a typical write event, a page of data from the processor's cache memory is transferred to the external memory 140 or, if cache is not enabled, the processor 120 directly generates the data and places the data and its corresponding address on a memory bus. As a result, data in a protected window 142 (“old data”) will be replaced with new data.

If a write event occurs during state 220, the method advances to state 240. At state 240, the processor 120 updates the reference hash value of each protected window that is affected by the write event. Control is then returned to state 220.

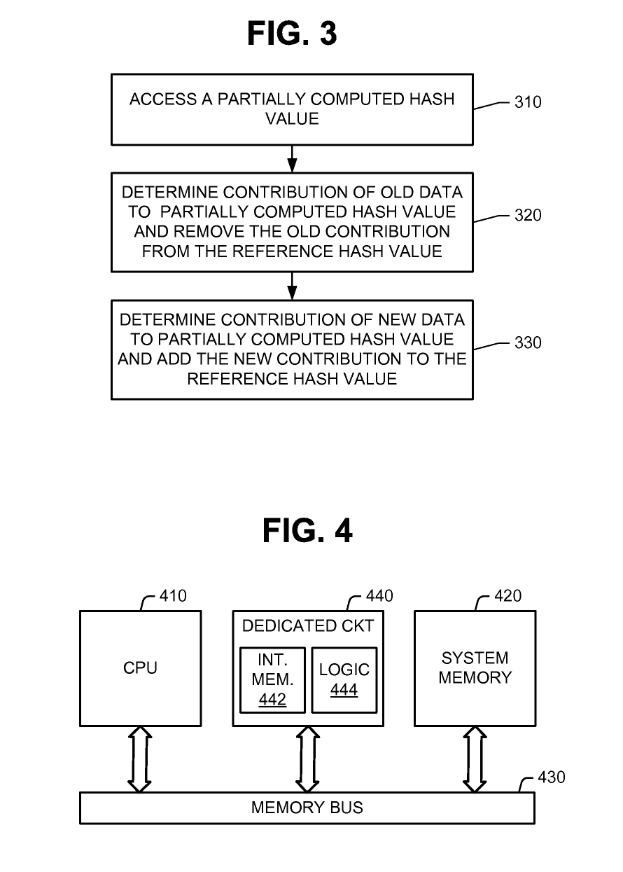

Reference is made to FIG. 3, which illustrates a method of updating a reference hash value for a protected window 142. At block 310, a current hash value for the protected window 142 has been partially computed at the time of a write event.

At block 320, a contribution of the old data to the partially computed hash value is determined, and that old contribution is removed from the reference hash value. In the case of an arithmetic sum, for instance, the old contribution is subtracted from the reference hash value. In the case of an XOR, the old contribution is XOR'ed again with the reference hash value. Other updatable hash functions that are more complex may each have their own update procedures.

At block 330, a contribution of the new data to the partially computed hash value is determined, and that new contribution is added to the reference hash value. In the case of an arithmetic sum, for instance, the new contribution is added to the reference hash value. In the case of an XOR, the new contribution is XOR'ed again with the reference hash value. Other updatable hash functions that are more complex may each have their own update procedures.

Updating the reference hash value is preferable to recomputing a new reference hash value. If new write events repeatedly occur while a new reference hash value is being recomputed, the loop may be constantly interrupted and may never finish.

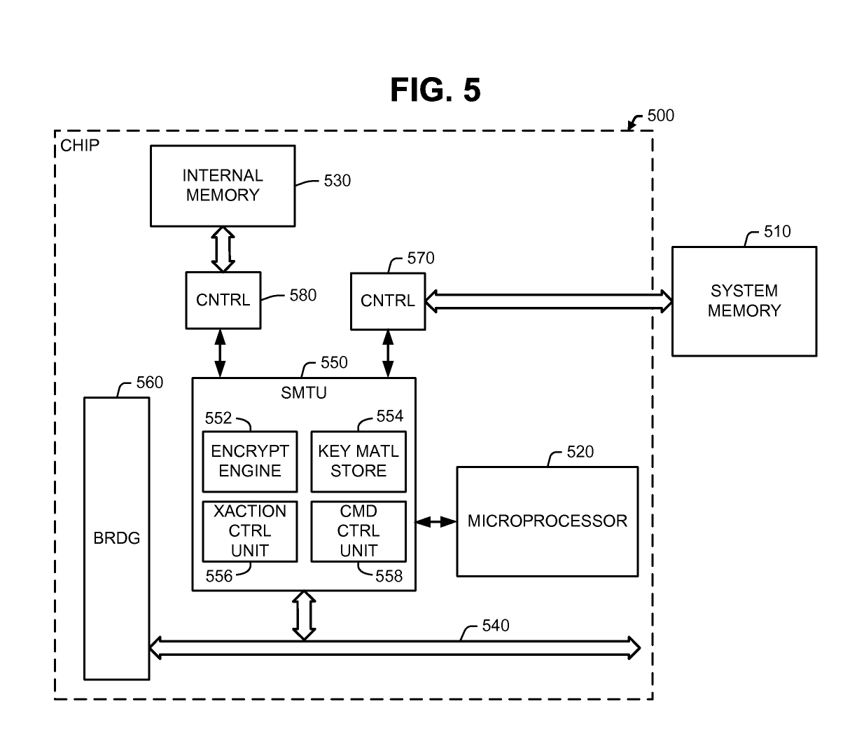

FIGS. 4 and 5 illustrate different examples of the computing system 110. The computing system 110 of FIG. 4 may be implemented on a computer circuit board (e.g., a motherboard, daughterboard, daughtercard, mezzanine board, piggyback board). The computing system 110 of FIG. 5 may be implemented as a system-on-a-chip.

Referring to FIG. 4, the computing system 110 includes a central processing unit (“CPU”) 410 and volatile system memory (e.g., DRAM) 420. The system memory 420 is part of external memory. The CPU 410 and the system memory 420 communicate over a memory bus 430.

The computing system 110 further includes a dedicated circuit 440 that also communicates over the memory bus 430 (in the alternative, the dedicated circuit 440 may communicate directly with the CPU 410 and the system memory 420). The dedicated circuit 440 can access the system memory 420, including data written to the system memory 420. The dedicated circuit 440 includes internal memory (e.g., internal registers) 442 and logic 444 for causing the dedicated circuit 440 to store the reference hash values in the internal memory 442, generate current hash values for protected windows in the system memory 420, compare the current hash values to the reference hash values, and update the reference hash values during write events. The logic 444 may be implemented, for example, as a state machine or a programmed processor. The logic 444 may generate an interrupt if a reference hash value does not match a generated hash value. The CPU 410 may respond to the interrupt by taking a reactive measure against a memory replay attack.

The security against memory replay attacks is not limited to writes by the CPU 410 to the system memory 420. For example, the security may cover write events by a DMA controller or a peripheral device.

In another example of the computing system 110, a multi-core CPU may provide security against memory replay attacks instead of the dedicated circuit 440. A dedicated core of the multi-core CPU core may, with appropriate firmware, provide the security. In yet another example, the security may be provided as a separate task running on the CPU.

In some examples of the computing system 110, the security may be extended to non-volatile memory such as hard drives and solid state memory. The internal memory would also be non-volatile.

Reference is now made to FIG. 5. The computing system 110 of FIG. 5 implements a system-on-a-chip (SoC) architecture similar to the SoC architecture described in assignee's U.S. Publication No. 20130117577. The computing system 110 of FIG. 5 includes a chip 500 and off-chip (external) volatile system memory (e.g., DRAM) 510. The chip 500 includes a microprocessor 520, volatile internal memory (e.g., EDRAM) 530, and a memory bus 540. Some configurations may follow a CoreConnect™ bus architecture for system-on-a-chip (SoC) designs, wherein the microprocessor 520 is a PowerPC core, and the memory bus 540 is a processor local bus (PLB).

The chip 500 also includes a dedicated circuit referred to as a secure memory transaction unit (“SMTU”) 550. The SMTU 550 communicates directly with the microprocessor 520, and it communicates with a bridge 560 via the memory bus 540. The SMTU 550 communicates with the system memory 510 via a first memory controller 570, and it communicates with the internal memory 530 via a second memory controller 580.

The SMTU 550 provides an encryption and authentication engine 552 for encrypting and authenticating data stored in the system memory 510. Dedicated memory referred to as a key material store 554 is used to store key material for the encryption and authentication. The SMTU 550 may act as a slave unit serving read and write requests initiated by the microprocessor 520 or by units coupled to the bridge 560.

The SMTU 550 is also configured to provide security against memory replay attacks. The encryption and authentication engine 552 may include an updatable hash function for computing the hash values for the protected windows. The SMTU 550 may also include a transaction control unit 556 for deciding which memory window is protected, and how it is protected; and a command control unit 558 having control registers and status registers for controlling the overall operation of the SMTU 550, including storing the reference hash values in the internal memory 530 and repeatedly comparing the current hash values to the reference hash values. Instead of storing the reference hash values in the internal memory 530, the reference hash values may instead be stored in register memory (not shown) within the SMTU 550.

The operation of the SMTU 550 is transparent to the microprocessor 520, as the microprocessor 520 only initiates the security and receives an interrupt at an error. Otherwise, the microprocessor 520 is not involved with encryption and security against memory replay attacks.

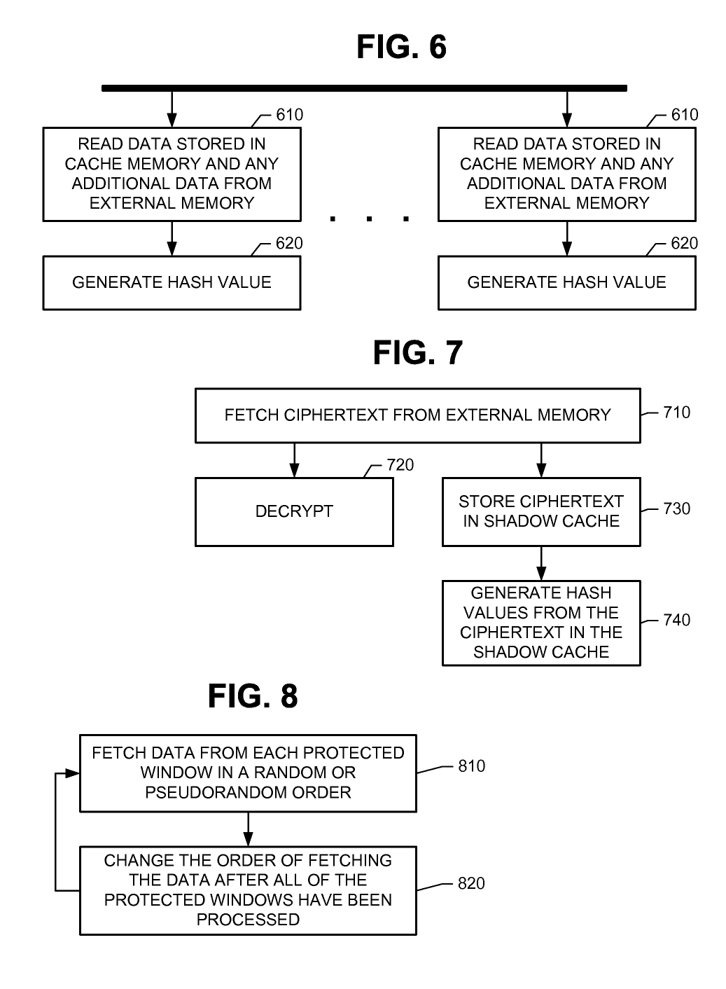

FIGS. 6, 7 and 8 are illustrations of enhancements to a method of providing security against memory replay attacks. These enhancements will be described in connection with the computing system 110 of FIG. 5. However, these enhancements may be used with the computing system 110 of FIG. 4 as well as other computing systems 110.

Reference is made to FIG. 6, which illustrates the use of cache memory of the microprocessor 520. During operation of the computing system 110, the microprocessor 520 may fetch data from the system memory 510 and store the fetched data in the microprocessor's cache memory. The cache memory also stores auxiliary data such as the physical address, dirty flag, etc.

At block 610, the SMTU 550 determines whether the data for a protected window is stored in the cache memory. If any such data is stored in the cache memory, the SMTU 550 reads that data from the cache memory. Any remaining data is read from the system memory 510. At block 620, the SMTU 550 generates a current hash value from that data.

Blocks 610 and 620 may be performed for each protected window. The protected windows may be processed concurrently, in parallel, or sequentially. FIG. 6 illustrates concurrent processing for a plurality of protected windows.

Accessing data from the microprocessor's cache memory is faster than fetching data from the system memory 510. As a result, the use of the cache memory can reduce the amount of time to process all of the protected windows. This, in turn, reduces the period of vulnerability to a memory replay attack. Accessing data from microprocessor's cache memory is also more secure, because data changed (replayed) in the system memory 510 after caching will not be seen by the microprocessor 520, and will not affect the computing system 110.

Reference is made to FIG. 7, which illustrates an enhancement to the processing of encrypted data. Ciphertext is fetched from the system memory 510 by the microprocessor 520 (block 710), the ciphertext is authenticated and decrypted by the SMTU 550, and the resulting plaintext may be stored in cache memory (not shown) of the SMTU 550 (block 720). The ciphertext is not needed by the microprocessor 520 and is typically discarded. Rather than discarding the ciphertext however, the SMTU 550 store the ciphertext in separate cache memory (“shadow cache”) until the plaintext is written out from the SMTU's cache memory (block 730). The hash values are generated from the ciphertext stored in the shadow cache (block 740). Utilizing the shadow cache is considerably faster rather than reading the ciphertext from the system memory 510. Moreover, by processing the ciphertext instead of the plaintext, the hash value generation is faster and power usage is reduced because decryption operations are skipped.

Reference is made to FIG. 8. It is possible for an attacker to analyze traffic on the data path between the first memory controller 570 and the system memory 510. The analysis can reveal memory access patterns. This, in turn, might allow an attacker to gain insights about the data in the protected windows.

Such traffic analysis may be thwarted by processing the data in each protected window in a random or pseudorandom order instead of a sequential or other fixed order (block 810). In a pseudorandom order some (pseudo-randomly chosen) memory locations may be visited repeatedly, thereby making the memory accesses even more unpredictable. The order of fetching the data may be determined, for example, according to a secret key or a random number generated by a random number generator.

At block 720, the order of fetching data in the protected windows is changed. The order may be changed after all of the protected windows have been processed. If a secret key is used to determine the order, the order may be changed by incrementing the secret key by a large odd constant. The secret key may be stored in the key material store 554 of the SMTU 550.

The computing system 110 is not limited to any particular usage. Examples include flight computers, personal computers, work stations, laptop computers, and smart mobile devices.

1. A method of providing security for data stored in external memory in a computing system, the computing system also including internal memory, the method comprising:
storing in the internal memory a reference updatable hash value for each protected window of the external memory; and
continually generating a current hash value for each protected window and comparing each current hash value to its corresponding reference hash value.

2. The method of claim 1, wherein the external memory includes volatile system memory.

3. The method of claim 1, wherein the reference and current hash values are checksums.

4. The method of claim 1, wherein the reference hash values are stored in the internal memory during system initialization; and wherein a reference hash value is updated at a write event.

5. The method of claim 4, wherein updating the reference hash value includes removing a contribution of old data, and adding a contribution of new data.

6. The method of claim 1, wherein the hash value generation and comparison are performed for all of the protected windows in a continual loop until a mismatch occurs or until a write event occurs.

7. The method of claim 1, further comprising taking a reactive measure against a memory replay attack if a current hash value does not match its corresponding reference hash value.

8. The method of claim 1, wherein the external memory includes system memory; wherein the computing system includes a central processing unit (CPU) that communicates with the external memory over a memory bus; wherein the computing system further includes a dedicated circuit including the internal memory; and wherein the dedicated circuit is used to access the system memory via the memory bus, store the reference hash values in the internal memory, generate the current hash values for the protected windows in system memory, and compare the current hash values to the reference hash values.

9. The method of claim 1, wherein the computing system includes a system-on-chip having a microprocessor, internal on-chip memory, and a secure memory transaction unit (SMTU); wherein the external memory is off-chip; and wherein the SMTU is used to access data in the external memory, compute and store the reference hash values in the internal on-chip memory, generate the current hash values for the protected windows, and compare the current hash values to the reference hash values.

10. The method of claim 1, wherein the computing system includes a processor having cache memory; and wherein the generated hash values are generated from data stored in the cache memory and all remaining data from the external memory.

11. The method of claim 1, wherein the external memory stores ciphertext; wherein the ciphertext is read from the external memory, stored in shadow cache memory and also decrypted to produce plaintext; and wherein the reference and current hash values are computed from the ciphertext in the shadow cache memory.

12. The method of claim 1, wherein data in the protected windows is fetched from the external memory in a random or pseudorandom order to obfuscate memory access patterns.

13. The method of claim 12, wherein the order of fetching the data in the protected windows is changed after all of the protected windows have been processed.

14. A computing system comprising:
volatile random access memory;
internal memory; and
a dedicated processor configured to store a reference updatable hash value for each protected window of the volatile memory, where each reference hash value is stored in the internal memory; and continually generate a current hash value for each protected window and compare each current hash value to its corresponding reference hash value.

15. A system-on-chip for protecting external memory from a memory replay attack, the system-on-chip comprising:
a microprocessor;
internal memory; and
a dedicated processor configured to store reference hash values corresponding to protected windows of the external memory, the reference hash values stored in the internal memory; and continually generate a current hash value for each protected window and compare each current hash value to its corresponding reference hash value.

16. The system-on-chip of claim 15, wherein the dedicated processor is further configured to thwart a memory replay attack if a generated hash value does not match its corresponding reference hash value.

17. The system-on-chip of claim 15, wherein the dedicated processor is configured to store the reference hash values in the internal memory during system initialization, and wherein the dedicated processor is configured to update a reference hash value at a write event.

18. The system-on-chip of claim 17, wherein updating the reference hash value includes removing a contribution of old data, and adding a contribution of new data.

19. The system-on-chip of claim 15, wherein the external memory stores ciphertext; wherein the ciphertext is fetched from the external memory; and wherein the dedicated processor is configured to decrypt the ciphertext, store the ciphertext in shadow cache memory, and compute the reference and current hash values from the ciphertext in the shadow cache memory.

20. The system-on-chip of claim 15, wherein the dedicated processor is further configured to fetch data from the external memory in a random or pseudorandom order to obfuscate memory access patterns.
